(19) United States
(12) Patent Application Publication
(10) Pub. No.: US 2019/0249979 A1
(43) Pub. Date: Aug. 15, 2019

(54) DEFORMATION DETECTION SENSOR FOR SEALED SECONDARY BATTERY AND SEALED SECONDARY BATTERY

(71) Applicant: TOYO TIRE CORPORATION, Itami-shi, Hyogo (JP)

(72) Inventors: Nobuyuki Minakata, Itami-shi (JP); Takeshi Fukuda, Itami-shi (JP)

(73) Assignee: TOYO TIRE CORPORATION, Itami-shi, Hyogo (JP)

(21) Appl. No.: 16/333,328

(22) PCT Filed: Apr. 7, 2017
(86) PCT No.: PCT/JP2017/014535

§ 371 Date: Mar. 14, 2019

(30) Foreign Application Priority Data
Oct. 28, 2016 (JP) 2016-212338

(51) Int. Cl. G01B 7/24; H01M 10/48

(52) U.S. Cl. CPC G01B 7/24; H01M 10/48

(57) ABSTRACT

This deformation detection sensor for a sealed secondary battery comprises: a polymer matrix layer attached to an exterior body among members constituting a battery; a casing sandwiching the exterior body together with the polymer matrix layer; a spacer layer sandwiched, along with the polymer matrix layer, between the exterior body and the casing; and a detection unit detecting a change in the external field arising in response to a deformation of the polymer matrix layer. When C is the surface area on a placement surface of the exterior body for attaching the polymer matrix layer and the spacer layer, A is the contact surface area between the placement surface and the polymer matrix layer, and B is the contact surface area between the placement surface and the spacer layer, the relationship 0.15≤(A+B)/C≤1 is established.

### TECHNICAL FIELD

The present disclosure relates to a deformation detection sensor for a sealed secondary battery and a sealed secondary battery to which the same is attached.

### BACKGROUND ART

In recent years, sealed secondary batteries represented by lithium ion secondary batteries (which may hereafter be simply referred to as “secondary batteries”) are used not only in mobile devices such as portable phones and notebook-type personal computers but also as a power source for electric vehicles such as electric automobiles and hybrid automobiles. A unit cell (cell) constituting a secondary battery includes an electrode group formed by winding or stacking a positive electrode and a negative electrode via a separator interposed therebetween, and an exterior body that accommodates the electrode group. Generally, a laminate film or a metal can is used as the exterior body, and the electrode group is accommodated together with an electrolytic solution in a sealed space located in the inside thereof.

For use that requires a high voltage such as in a power source for the above-described electric vehicles, the secondary battery is used in a mode of a battery module or a battery pack that includes a plurality of cells. In the battery module, a plurality of cells connected in series are accommodated in a casing. For example, four cells are connected in an array of two in parallel by two in series or in an array of four in series. Also, in the battery pack, various apparatus such as a controller are accommodated in the casing, in addition to the plurality of battery modules connected in series. In the secondary battery used in the power source for an electric vehicle, the casing of the battery pack is formed in a shape that is suitable for mounting on the vehicle.

Such a secondary battery raises a problem in that, when the electrolytic solution is decomposed due to overcharging or the like, the cells swell in accordance with the rise in internal pressure caused by the decomposed gas, whereby the secondary battery is deformed. In that case, ignition occurs unless the charging current or the discharging current is stopped. In the worst case, the ignition results in rupture of the secondary battery. Therefore, in preventing rupture of the secondary battery, it is important to detect deformation of the secondary battery caused by swelling of the cells with a high degree of sensitivity so that the charging current or the discharging current can be stopped at a suitable time.

Patent Document 1 discloses a configuration in which a spacer having a metal frame and a pressure sensor attached to the spacer are disposed in a gap between adjacent batteries and when the battery swells, the sensor is brought into contact with the battery so as to be capable of detecting the swelling of the battery. However, with this configuration, only the pressure sensor is brought into contact with the battery, so that positional shift or stress concentration is generated due to external turbulence such as a vibration, thereby raising a fear that the detection precision may fluctuate.

Patent Document 2 discloses a deformation detection sensor configured to include a polymer matrix layer containing a magnetic filler, which is disposed between adjacent batteries or between the battery and the casing, and a detection unit that detects change in the external field accompanying the deformation of the polymer matrix layer. However, with this configuration, the pressure from the battery is applied only to the polymer matrix layer, so that positional shift or stress concentration is generated due to external turbulence such as a vibration, thereby raising a fear that the detection precision may fluctuate.

### PRIOR ART DOCUMENTS

### Patent Documents

Patent Document 1: JP-A-2015-138649

Patent Document 2: International Patent Publication No. 2016/0002454

### SUMMARY OF THE INVENTION

### Problems to be Solved by the Invention

The present disclosure has been made in view of such circumstances, and an object thereof is to provide a deformation detection sensor for a sealed secondary battery with improved sensor sensitivity in which the stability of defection is improved even when an external turbulence such as a vibration is applied.

### Means for Solving the Problems

To solve the foregoing problem, the present disclosure employs means as described below.

According to the present disclosure, there is provided a deformation detection sensor for a sealed secondary battery, the deformation detection sensor including: a polymer matrix layer attached to a deformation detection object member among members constituting a battery; an opposite member sandwiching said polymer matrix layer together with said deformation detection object member; a spacer layer sandwiched, along with said polymer matrix layer, between said deformation detection object member and said opposite member; and a detection unit detecting a change in an external field arising in response to a deformation of said polymer matrix layer, wherein, in a planar view as viewed from said opposite member, when C is a surface area on a placement surface of said deformation detection object member for attaching said polymer matrix layer and said spacer layer. A is a contact surface area between said placement surface and said polymer matrix layer, and B is a contact surface area between said placement surface and said spacer layer, then a relationship of 0.15≤(A+B)/C≤1 is established.

According to this construction, a structure is provided in which the polymer matrix layer and the spacer layer are sandwiched between the deformation detection object member and the opposite member, and the spacer layer maintains the positional relationship between the deformation detection object member and the opposite member, so that the detection stability against the positional shift caused by vibration can be improved.

### BRIEF DESCRIPTION OF THE DRAWINGS

FIG. 1A is a perspective view schematically illustrating a deformation detection sensor for a sealed secondary battery according to the fist embodiment of the present disclosure.

FIG. 1B is an A-A sectional view in FIG. 1A.

FIG. 2A is a plan view illustrating an arrangement of a placement surface of a deformation detection object member, a spacer layer, and a polymer matrix layer in Example 1.

FIG. 2B is a sectional view illustrating a relationship among the placement surface of the deformation detection object member, the spacer layer, and the polymer matrix layer.

FIG. 3A is a plan view illustrating an arrangement of a placement surface of a deformation detection object member, a spacer layer, and a polymer matrix layer in Example 2.

FIG. 3B is a plan view illustrating an arrangement of a placement surface of a deformation detection object member, a spacer layer, and a polymer matrix layer in Example 3.

FIG. 3C is a plan view illustrating an arrangement of a placement surface of a deformation detection object member, a spacer layer, and a polymer matrix layer in Comparative Example 1.

FIG. 4A is a plan view illustrating an arrangement of a placement surface of a deformation detection object member, a spacer layer, and a polymer matrix layer in a modification.

FIG. 4B is a plan view illustrating an arrangement of a placement surface of a deformation detection object member, a spacer layer, and a polymer matrix layer in a modification.

FIG. 5 is a sectional view schematically illustrating a deformation detection sensor for a sealed secondary battery according to the first embodiment.

### MODE FOR CARRYING OUT THE INVENTION

Hereafter, embodiments of the present disclosure will be described.

### First Embodiment

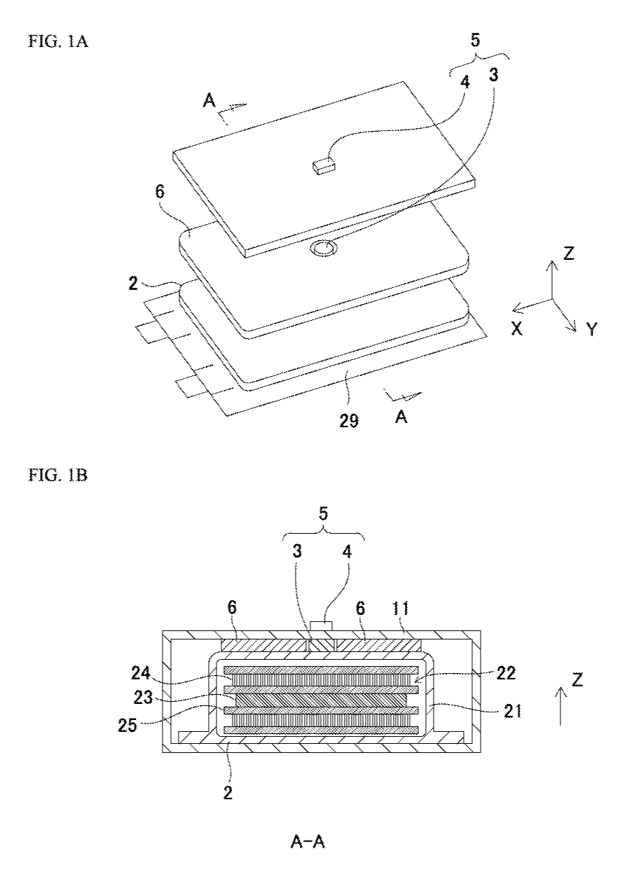

To a sealed secondary battery 2 shown in FIGS. 1A and 1B, a deformation detection sensor 5 for detecting a deformation of the secondary battery 2 is attached. The deformation detection sensor 5 has a polymer matrix layer 3 and a detection unit 4. A unit cell constituting this secondary battery 2 has a structure in which an electrode group 22 is accommodated in the inside of a sealed exterior body 21. The electrode group 22 of the present embodiment is formed by stacking a positive electrode 23 and a negative electrode 24 with a separator 25 interposed therebetween, and such a stacked body is enclosed within the exterior body 21 together with an electrolytic solution. A leading wire is connected to each of the positive electrode 23 and the negative electrode 24, and an end thereof protrudes to the outside of the exterior body 21 so as to constitute an electrode terminal.

The secondary battery 2 of the present embodiment is a laminate battery using a laminate film, such as an aluminum laminate foil, as the exterior body 21, and is specifically a laminate type lithium ion secondary battery having a capacity of 1.44 Ah. The exterior body 21 has a plurality of walls and a welded part 29 formed on three surrounding sides, so as to be formed in a thin rectangular parallelepiped shape as a whole. The X-, Y-, and Z-directions correspond to the length direction, width direction, and thickness direction of the secondary battery 2, respectively.

In FIGS. 1A and 1B, only one secondary battery 2 serving as a unit cell is shown. However, for use that requires a high voltage such as in a power source for an electric vehicle, the secondary battery 2 is used in a form of a battery module including a plurality of unit cells. In the battery module, a plurality of unit cells constitute an assembled battery to be accommodated within a casing 11. Generally, a battery module mounted on a vehicle is used in a form of a battery pack. In the battery pack, a plurality of battery modules are connected in series, and these are accommodated in the casing together with various apparatus such as a controller. The casing of the battery pack is formed in a shape suitable for mounting on a vehicle, for example, in a shape that accords to the under-floor shape of the vehicle. The secondary battery 2 is accommodated in the casing 11.

The polymer matrix layer 3 is bonded to the exterior body 21 of the secondary battery 2. The polymer matrix layer 3 contains a magnetic filler that is dispersed therein and that gives a change in an external field in accordance with a deformation of the polymer matrix layer 3. The detection unit 4 detects the change in the external field accompanying the deformation of the polymer matrix layer 3. The polymer matrix layer 3 of the present embodiment is formed in a sheet shape from an elastomer material capable of flexible deformation that accords to swelling of the secondary battery 2. When a deformation is generated in the exterior body 21 by the swelling of the secondary battery 2, the polymer matrix layer 3 is deformed in accordance therewith, and the change in the external field accompanying the deformation of the polymer matrix layer 3 is detected by the detection unit 4. On the basis of this, the deformation of the secondary battery 2 can be detected with a high sensitivity.

In the present embodiment, the polymer matrix layer 3 and the spacer layer 6 are sandwiched between the casing 11 and an outer surface (exterior body 21) of the secondary battery 2 that is accommodated in the casing 11. The polymer matrix layer 3 is attached to the exterior body 21 which is a deformation detection object member among the members constituting the battery. The casing 11 is an opposite member that sandwiches the polymer matrix layer 3 together with the exterior body 21 which is the deformation detection object member. The spacer layer 6 is sandwiched, along with the polymer matrix layer 3, between the deformation detection object member (exterior body 21) and the opposite member (casing 11). The detection unit 4 is fixed to the outside of the opposite member (casing 11), so that a positional relationship between the polymer matrix layer 3 and the deformation detection object member (exterior body 21) is maintained. In the present embodiment, the distance between the deformation detection object member (exterior body 21) and the opposite member (casing 11) is set to be smaller than the thickness of the polymer matrix layer 3 and the spacer layer 6 in a natural state in which no external force is exerted. This allows the polymer matrix layer 3 and the spacer layer 6 to be sandwiched in a state of being compressed by the exterior body 21 and the casing 11; however, the present invention is not limited to this alone. For example, it is possible to set a state in which the polymer matrix layer 3 and the spacer layer 6 are not compressed.

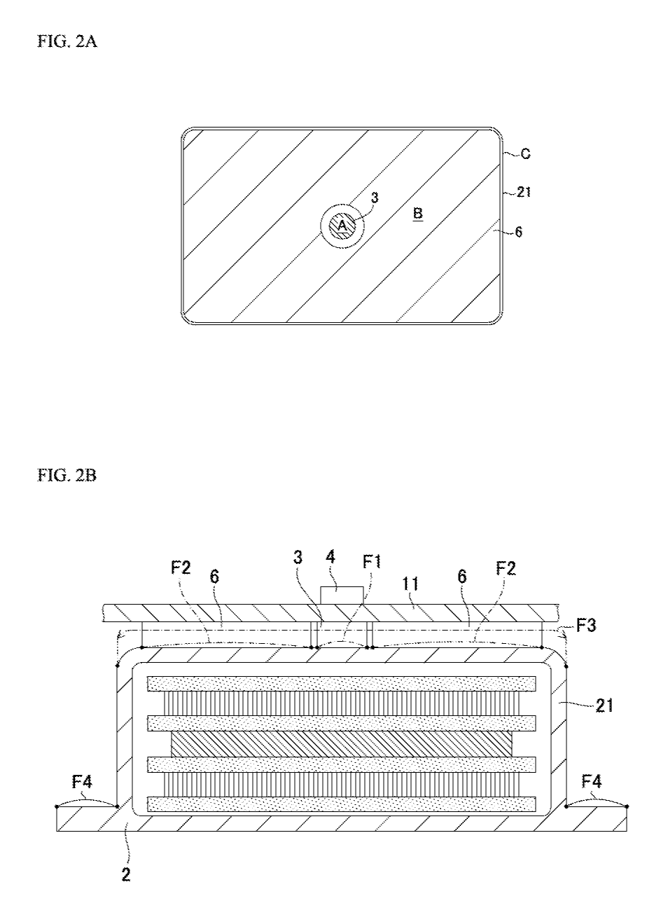

Referring to FIGS. 2A and 2B, in a planar view as viewed from the opposite member (11), when C is a surface area on a placement surface F3 of the deformation detection object member (exterior body 21) for attaching the polymer matrix layer 3 and the spacer layer 6, A is a contact surface area F1 between the placement surface F3 and the polymer matrix layer 3, and B is a contact surface area F2 between the placement surface F3 and the spacer layer 6, then a relationship of 0.15≤(A+B)/C≤1 is established. In the example shown in FIG. 2A, (A+B)/C=0.9 is satisfied. When (A+B)/C<0.15 is satisfied, the effect of the spacer layer 6 of maintaining the positional relationship between the deformation detection object member and the opposite member will be insufficient in accordance with the decrease in the contact surface area. When the polymer matrix layer 3 and the spacer layer 6 are bonded to the whole of the placement surface F3, then (A+B)/C=1 is satisfied.

Referring to FIG. 2B, the placement surface F3 means a surface which is a part of the surface of the deformation detection object member (exterior body 21) and opposes the opposite member (casing 11) and which is continuous to the site where the polymer matrix layer 3 and the spacer layer 6 are attached in a planar view. Therefore, the surface F4 which is a part of the surface of the deformation detection object member (exterior body 21) and opposes the opposite member (casing 11) and which is not continuous to the site where the polymer matrix layer 3 and the spacer layer 6 are attached in a planar view, cannot be said to be a placement surface.

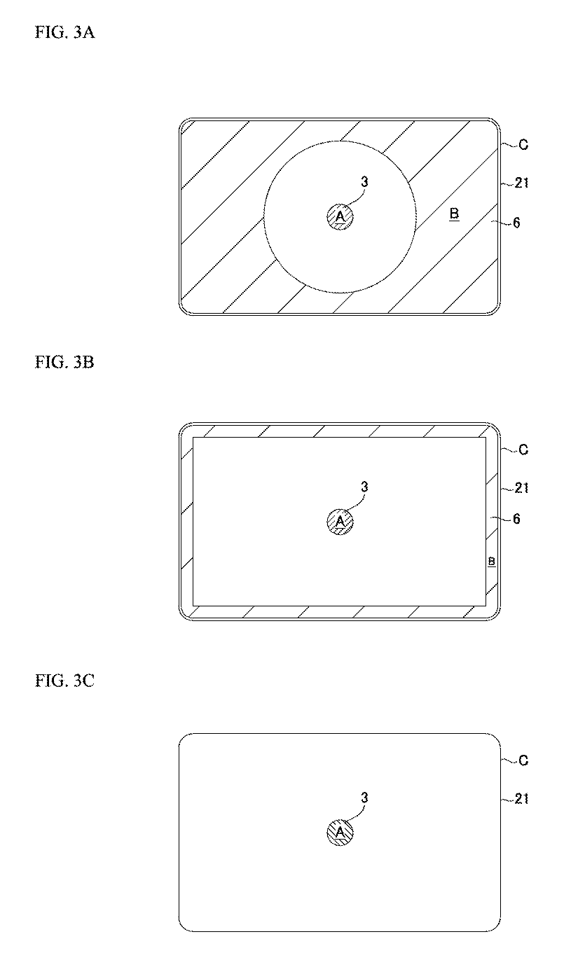

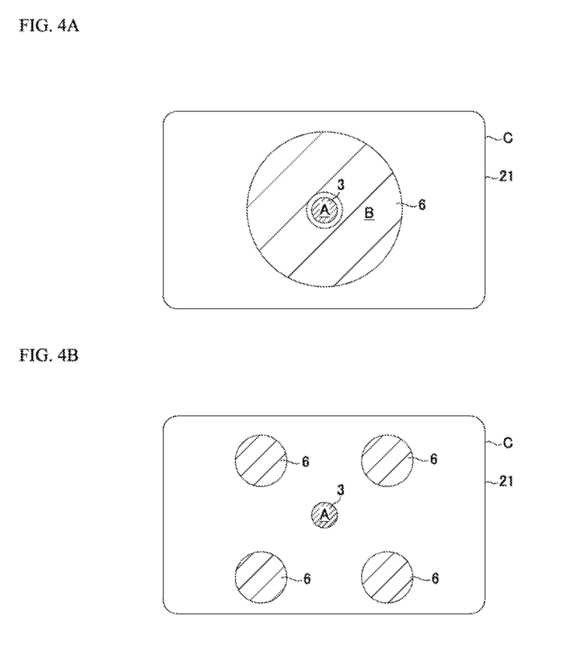

Various modes can be mentioned as the arrangement pattern of the spacer layer 6. For example, in the example shown in FIG. 3A, (A+B)/C=0.5 is satisfied. The spacer layer 6 is arranged to avoid a predetermined region in the surroundings of the polymer matrix layer 3. In the example shown in FIG. 3B, (A+B)/C=0.18 is satisfied. In the example shown in FIG. 4A, the spacer layer 6 is arranged to be adjacent to the polymer matrix layer 3. In the example shown in FIG. 4B, a plurality of spacer layers 6 are separately arranged around the polymer matrix layer 3. Though even FIG. 4B can produce an effect, it is preferable that, in a planar view, the spacer layer 6 is arranged in an annular shape surrounding the polymer matrix layer 3, as shown in FIGS. 2A, 3A to 3B, and 3A. This is because forces in all directions can be supported and received.

Here, the example shown in FIG. 3C is a Comparative Example with no spacer layer 6 and with A/C=0.11 being satisfied.

In the example shown in FIG. 2A of the present embodiment, a silicone resin (SE1740 manufactured by Dow Corning Toray Co., Ltd.) (ϕ20×2 mm had been stamped out at the center of 90×30×2 mm) serving as a spacer layer 6 and a magnetic silicone resin (ϕ10×2 mm) serving as a polymer matrix layer 3 were bonded to an exterior body 21 of a unit cell (size: longitudinal 90×lateral 30×thickness 4 mm) of 1.44 Ah. These resin members and the battery were accommodated in a battery casing 11 (120×60×6 mm), and a magnetic sensor (EQ-431L manufactured by Asahi Kasei Microdevices Corporation) serving as a detection unit 4 was placed in the battery casing so as to be positioned above the center of the magnetic silicone resin.

The spacer layer 6 is preferably deformed without inhibiting the deformation of the polymer matrix layer 3. Accordingly, when Ma is an elastic modulus of the polymer matrix layer 3, and Mb is an elastic modulus of the spacer layer 6, it is preferable that a relationship of 0.02≤Mb/Ma≤500 is established. When 0.02>Mb/Ma is satisfied, there is raised a problem in that, by vibration, the spacer layer 6 follows to such a degree that the positional relationship between the deformation detection object member and the opposite member cannot be maintained, thereby generating a positional shift. When Mb/Ma>500 is satisfied, there is raised a problem in that the spacer layer 6 hardly follows the vibration and slides to generate a positional shift.

In particular, Mb≤Ma is preferably satisfied. This relation leads to a situation in which, when the polymer matrix layer 3 is about to be deformed in accordance with the deformation of the deformation detection object member (exterior body 21), the spacer layer 6 is deformed together without inhibiting the deformation, so that the sensitivity can be readily ensured. Also, when Mb≤Ma is satisfied, it is preferable that 0.4≤(A+B)/C≤1 is satisfied, and more preferably 0.7≤(A+B)/C≤1 is satisfied, because the larger the supporting area brought by the spacer layer 6 is, the better it is.

The elastic modulus is measured in the following manner. A fabricated magnetic silicone resin serving as the polymer matrix layer 3 was stamped out to a size of ϕ30×10 mm and put into a thermostatic tank of 25° C. Then, compression up to a strain of 30% was repeated for 3 cycles with a universal testing machine (autograph AG-10 kNXplus manufactured by Shimadzu Corporation), and the compression elastic modulus (Ma) was measured using a slope of the strain of 24 to 26% at the third cycle.

Also, a commercially available silicone resin having an arbitrary hardness was selected as the spacer layer 6, and the compression elastic modulus (Mb) was measured by a similar method. From the elastic moduli of the two members. [Mb/Ma] was calculated, and this was determined as the elastic modulus ratio. It is shown that the larger this value is, the higher the elasticity of the spacer layer 6 is as compared with the polymer matrix layer 3.

The present embodiment is an example in which the polymer matrix layer 3 contains a magnetic filler as the above-described filler, and the detection unit 4 detects change in a magnetic field as the above-described external field. In this case, the polymer matrix layer 3 is preferably a magnetic elastomer layer in which the magnetic filler is dispersed in a matrix that contains an elastomer component.

The magnetic filler may be, for example, a rare-earth-based, iron-based, cobalt-based, nickel-based, or oxide-based filler; however, a rare-earth-based filler is preferable because a higher magnetic force can be obtained. The shape of the magnetic filler is not particularly limited, so that the shape may be any one of spherical, flattened, needle-like, prismatic, and amorphous shapes. The average particle size of the magnetic filler is preferably from 0.02 to 500 μm, more preferably from 0.1 to 400 μm, and still more preferably from 0.5 to 300 μm. When the average particle size is smaller than 0.02 μm, the magnetic characteristics of the magnetic filler tend to deteriorate. On the other hand, when the average particle size exceeds 500 μm, the mechanical properties of the magnetic elastomer layer tend to deteriorate, and the magnetic elastomer layer tends to be brittle.

The magnetic filler may be introduced into the elastomer after magnetization; however, it is preferable to magnetize the magnetic filler after introduction into the elastomer. By magnetization after introduction into the elastomer, the polarity of the magnet can be easily controlled, and the magnetic field can be easily detected.

A thermoplastic elastomer, a thermosetting elastomer, or a mixture of these can be used as the elastomer component. Examples of the thermoplastic elastomer include a styrene-based thermoplastic elastomer, a polyolefin-based thermoplastic elastomer, a polyurethane-based thermoplastic elastomer, a polyester-based thermoplastic elastomer, a polyamide-based thermoplastic elastomer, a polybutadiene-based thermoplastic elastomer, a polyisoprene-based thermoplastic elastomer, and a fluororubber-based thermoplastic elastomer. Also, examples of the thermosetting elastomer include diene-based synthetic rubbers such as polyisoprene rubber, polybutadiene rubber, styrene-butadiene rubber, polychloroprene rubber, nitrile rubber, and ethylene-propylene rubber, non-diene-based synthetic rubbers such as ethylene-propylene rubber, butyl rubber, acrylic rubber, polyurethane rubber, fluororubber, silicone rubber, and epichlorohydrin rubber, and natural rubbers. Among these, a thermosetting elastomer is preferable, and this is because settling of the magnetic elastomer accompanying the heat generation or overloading of the battery can be suppressed. Further, a polyurethane rubber (which may also be referred to as a polyurethane elastomer) or a silicone rubber (which may also be referred to as a silicone elastomer) is more preferable.

A polyurethane elastomer can be obtained by reacting a polyol with a polyisocyanate. In the case in which the polyurethane elastomer is used as the elastomer component, a magnetic filler is mixed with a compound containing active hydrogen, and further an isocyanate component is added thereto to obtain a mixture liquid. Also, a mixture liquid can also be obtained by mixing a magnetic filler with an isocyanate component, and mixing a compound containing active hydrogen thereto. The magnetic elastomer can be produced by injecting the mixture liquid into a mold that has been subjected to a releasing treatment, and thereafter heating the mixture liquid up to a curing temperature for curing. Also, in the case in which a silicone elastomer used as the elastomer component, the magnetic elastomer can be produced by putting a magnetic filler into a precursor of a silicone elastomer, mixing the components, putting the resulting mixture into a mold, and thereafter heating the mixture for curing. A solvent may be added as necessary.

A compound known in the art in the field of polyurethane can be used as the isocyanate component that can be used in the polyurethane elastomer. Examples of the isocyanate component include aromatic diisocyanates such as 2,4-toluene diisocyanate, 2,6-toluene diisocyanate, 2,2′-diphenylmethane diisocyanate 2,4′-diphenylmethane diisocyanate, 4,4′-diphenylmethane diisocyanate, 1,5-naphthalene diisocyanate, p-phenylene diisocyanate, m-phenylene diisocyanate, p-xylylene diisocyanate, and m-xylylene diisocyanate, aliphatic diisocyanates such as ethylene diisocyanate, 2,2,4-trimethylhexamethylene diisocyanate, and 1,6-hexamethylene diisocyanate, and alicyclic diisocyanates such as 1,4-cyclohexane diisocyanate, 4,4′-dicyclohexylmethane diisocyanate isophorone diisocyanate, and norbornane diisocyanate. These may be used either alone or as a mixture of two or more kinds. Also, the isocyanate component may be a modified component such as a urethane-modified, allophanate-modified, biuret-modified, or isocyanurate-modified component. Preferable isocyanate components are 2,4-toluene diisocyanate, 2,6-toluene diisocyanate, and 4,4′-diphenylmethane diisocyanate. 2,4-toluene diisocyanate or 2,6-toluene diisocyanate is more preferable.

A compound typically used in the technical field of polyurethane can be used as the compound containing active hydrogen. Examples of the compound containing active hydrogen include high-molecular-weight polyols such as polyether polyols represented by polytetramethylene glycol, polypropylene glycol, polyethylene and a copolymer of propylene oxide and ethylene oxide, polyester polyols represented by polybutylene adipate, polyethylene adipate, and 3-methyl-1,5-pentane adipate, polyester polycarbonate polyols typified by reaction products of alkylene carbonate and polyester glycol such as polycaprolactone polyol or polycaprolactone, polyester polycarbonate polyols obtained by reacting ethylene carbonate with a polyhydric alcohol and subsequently reacting the obtained reaction mixture with an organic dicarboxylic acid, and polycarbonate polyols obtained by transesterification reaction of a polyhydroxyl compound and aryl carbonate. These may be used either alone or as a mixture of two or more kinds.

In addition to the above-described high-molecular-weight polyol components, low-molecular-weight polyol components such as ethylene glycol, 1,2-propylene glycol, 1,3-propylene glycol, 1,4-butanediol, 1,6-hexanediol, neopentyl glycol, 1,4-cyclohexanedimethanol, 3-methyl-1,5-pentanediol, diethylene glycol, triethylene glycol, 1,4-bis(2-hydroxyethoxy)benzene, trimethylolpropane, glycerin, 1,2,6-hexanetriol, pentaerythritol, tetramethylolcyclohexane, methylglucoside, sorbitol, mannitol, dulcitol, sucrose, 2,2,6,6-tetrakis(hydroxymethyl)cyclohexanol, and triethanolamine, and low-molecular-weight polyamine components such as ethylenediamine, tolylenediamine, diphenylmethanediamine, and diethylenetriamine may be used as the compound containing active hydrogen. These may be used either alone or as a mixture of two or more kinds. Further, polyamines typified by 4,4′-methylenebis(o-chloroaniline) (MOCA), 2,6-dichloro-p-phenylenediamine, 4,4′-methylenebis(2,3-dichloroaniline), 3,5-bis(methylthio)-2,4-toluenediamine, 3,5-bis(methylthio)-2,6-toluenediamine, 3,5-diethyltoluene-2,4-diamine, 3,5-diethyltoluene-2,6-diamine, trimethyleneglycol-di-p-aminobenzoate, polytetramethyleneoxide-di-p-aminobenzoate, 1,2-bis(2-aminophenylthio)ethane, 4,4′-diamino-3,3′-diethyl-5,5′-dimethyldiphenylmethane. N,N′-di-sec-butyl-4,4′-diaminodiphenylmethane, 4,4′-diamino-3,3′-diethyldiphenylmethane, 4,4′-diamino-3,3′-diethyl-5,5′-dimethyldiphenylmethane, 4,4′-diamino-3,3′-diisopropyl-5,5′-dimethyldiphenylmethane, 4,4′-diamino-3,3′,5,5′-tetraethyldiphenylmethane, 4,4′-diamino-3,3′,5,5′-tetraisopropyldiphenylmethan, m-xylylenediamine, N,N′-di-sec-butyl-p-phenylenediamine, m-phenylenediaimine, and p-xylylenediamine may also be mixed. Preferable compounds containing active hydrogen are polytetramethylene glycol, polypropylene glycol, a copolymer of propylene oxide and ethylene oxide, and 3-methyl-1,5-pentane adipate. More preferable compounds containing active hydrogen are polypropylene glycol and a copolymer of propylene oxide and ethylene oxide.

A preferable combination of the isocyanate component and the compound containing active hydrogen is a combination of one kind or two more kinds of 2,4-toluene diisocyanate, 2,6-toluene diisocyanate, and 4,4′-diphenylmethane diisocyanate as the isocyanate component and one kind or two more kinds of polytetramethylene glycol, polypropylene glycol, a copolymer of propylene oxide and ethylene oxide, and 3-methyl-1,5-pentane adipate as the compound containing active hydrogen. A more preferable combination is a combination of 2,4-toluene diisocyanate and/or 2,6-toluene diisocyanate as the isocyanate component and polypropylene glycol and/or a copolymer of propylene oxide and ethylene oxide as the compound containing active hydrogen.

The polymer matrix layer 3 may be a foamed body containing a dispersed filler and bubbles. A general resin foam can be used as the foamed body. However, in view of the characteristics such as compression set, it is preferable to use a thermosetting resin foam. Examples of the thermosetting resin foam include polyurethane resin foam and silicone resin foam. Among these, polymethane resin foam is preferable. The isocyanate component and the compound containing active hydrogen that have been listed above can be used for the polyurethane resin foam.

The amount of the magnetic filler in the magnetic elastomer is preferably 1 to 450 parts by weight, more preferably 2 to 400 parts by weight, relative to 100 parts by weight of the elastomer component. When the amount is smaller than 1 part by weight, detection of change in the magnetic field tends to be difficult. When the amount exceeds 450 parts by weight, the magnetic elastomer itself may in some cases become brittle.

For the purpose of preventing rusts of the magnetic filler or the like, a sealing material for sealing the polymer matrix laser 3 may be provided to such a degree that the flexibility of the polymer matrix layer 3 is not deteriorated. A thermoplastic resin, a thermosetting resin, or a mixture of these may be used as the sealing material. The thermoplastic resin may be, for example, styrene-based thermoplastic elastomer, polyolefin-based thermoplastic elastomer, polyurethane -based thermoplastic elastomer, polyester-based thermoplastic elastomer, polyamide-based thermoplastic elastomer, polybutadiene-based thermoplastic elastomer, polyisoprene-based thermoplastic elastomer, fluorine-based thermoplastic elastomer, ethylene-ethylacrylate copolymer, ethylene-vinyl acetate copolymer, polyvinyl chloride, polyvinylidene chloride, chlorinated polyethylene, fluororesin, polyamide, polyethylene, polypropylene, polyethylene terephthalate, polybutylene terephthalate, polystyrene, polybutadiene, or the like. The thermosetting resin may be, for example, diene-based synthetic rubbers such as polyisoprene rubber, polybutadiene rubber, styrene-butadiene rubber, polychloroprene rubber, and acrylonitrile-butadiene rubber, non-diene-based rubbers such as ethylene-propylene rubber, ethylene propylenediene rubber, butyl rubber, acrylic rubber, polyurethane rubber, fluorine-containing rubber, silicone rubber, and epichlorohydrin rubber, natural rubbers, and thermosetting resins such as polyurethane resin, silicone resin, epoxy resin, or the like. These films may be stacked or may be a film including a metal foil such as aluminum foil or a metal vapor-deposition film including a metal vapor-deposited on the above-described film.

The polymer matrix layer 3 may be one in which the filler is unevenly distributed in the thickness direction thereof. For example, the polymer matrix layer 3 may be made of two layers, that is, a region on a one side containing a relatively larger amount of the filler and a region on the other side containing a relatively smaller amount of the filler. In the region that is located on the one side and that contains a larger amount of the filler, a large change in the external field results from small deformation of the polymer matrix layer 3, so that the sensor sensitivity to a low internal pressure can be enhanced. Also, a region that is located on the other side and that contains a relatively smaller amount of the filler is comparatively flexible and can be easily moved. Therefore, by attaching this region located on the other side, the polymer matrix layer 3 (particularly the region located on the one side) becomes capable of being easily deformed.

The filler uneven distribution ratio in the region on the one side preferably exceeds 50, and is more preferably 60 or more, still more preferably 70 or more. In this case, the filler uneven distribution ratio in the region on the other side is less than 50. The filler uneven distribution ratio in the region on the one side is 100 at the maximum, and the filler uneven distribution ratio in the region on the other side is 0 at the minimum. Therefore, it is possible to adopt a stacked body structure including an elastomer layer that contains a filler and an elastomer layer that does not contain the filler. For uneven distribution of the filler, it is possible to use a method in which, after the filler is introduced into the elastomer component, the resultant is left to stand still at room temperature or at a predetermined temperature, so as to attain natural settling of the filler by the weight of the filler. By changing the temperature or time for leaving the filler to stand still, the filler uneven distribution ratio can be adjusted. The filler may be distributed unevenly by using a physical force such as a centrifugal force or a magnetic force. Alternatively, the polymer matrix layer may be composed of a stacked body made of a plurality of layers having different contents of the filler.

The filler uneven distribution ratio is measured by the following method. That is, the cross-section of the polymer matrix layer is observed at a magnification of 100 times by using a scanning electron microscope—energy dispersive X-ray analyzer (SEM-EDS). The existence amount of the metal element inherent in the filler (for example, Fe element in the magnetic filler of the present embodiment) is determined by element analysis for the whole region in the thickness direction of the cross-section and for each of the two regions obtained by equally dividing the cross-section into two in the thickness direction. With respect to this existence amount, the ratio of the existence amount in the region on the one side relative to the existence amount in the whole region in the thickness direction is calculated, and this is determined as the filler uneven distribution ratio in the region on the one side. The filler uneven distribution ratio in the region on the other side can be determined in the same manner.

The region on the other side containing a relatively smaller amount of the filler may have a structure formed of a foamed body containing bubbles. This allows that the polymer matrix layer 3 can be more easily deformed, so that the sensor sensitivity is enhanced. Also, the region on the one side as well as the region on the other side may be formed of a foamed body. In this case, the whole of the polymer matrix layer 3 is made of a foamed body. The polymer matrix layer in which at least a part thereof in the thickness direction is made of a foamed body may be composed of a stacked body including a plurality of layers (for example, a non-foamed layer that contains a filler and a foamed layer that does not contain a filler).

As the detection unit 4 for detecting change in the magnetic field, a magnetic resistance element, a Hall element, an inductor, an MI element, a flux gate sensor, or the like can be used, for example. As the magnetic resistance element, a semiconductor compound magnetic resistance element, an anisotropic magnetic resistance element (AMR), a gigantic magnetic resistance element (GMR), and a tunnel magnetic resistance element (TMR) may be mentioned as examples. Among these, a Hall element is preferable, and this is because the Hall element has high sensitivity in a wide range, and is useful as the detection unit 4. As the Hall element, EQ-431L manufactured by Asahi Kasei Microdevices Corporation can be used, for example.

The following evaluation was made on the following Examples in order to specifically show the effects of the deformation detection sensor of the present disclosure.

### (1) Sensor Sensitivity

A battery casing in which a battery had been enclosed was put into a thermostatic tank of 25° C. After being quietly left to stand for 120 minutes, the battery body was subjected to constant-current charging up to 4.3 V with a charging current of 1.44 A (1 C). After the voltage reached 4.3 V, the battery body was subjected to constant-voltage charging until the electric current value decayed to 0.07 A. Subsequently, after an open circuit state was held for 10 minutes, the battery body was subjected to constant-current discharging down to 3.0 V with an electric current of 1.44 A. The above charging/discharging step was repeated for 3 cycles, and a change in magnetic flux density was measured at the charging/discharging time of the third cycle. The measurement was carried out for 5 times, and an average value thereof was determined as the sensor sensitivity. It is shown that the larger the amount of this change is, the more excellent the performance of the sensor is.

### (2) Stability

A battery casing in which a battery had been enclosed was set in a vibration tester, and a sinusoidal wave having a frequency of 200 Hz and an amplitude of 0.8 mm (total amplitude of 1.6 mm) was given to perform a vibration test. Here, the sinusoidal wave was applied in three directions that were perpendicular to each other, each for 3 hours. After the vibration test, the battery casing was put into a thermostatic tank of 25° C. again and, after being quietly left to stand for 120 minutes, the battery body was subjected to evaluation of the sensor characteristics by the aforementioned evaluation method. Next, from the sensor sensitivity (xa) before the vibration test and the sensor sensitivity (xb) after the vibration test, the value of [|xb−xa|xa] was calculated, and this was determined as the sensor stability. It is shown that the smaller this value is, the more excellent the stability of the sensor is.

### EXAMPLE 1

A silicone resin (SE1740 manufactured by Dow Corning Toray Co., Ltd.) (ϕ20×2 mm had been stamped out at the center of 90×30×2 mm) serving as a spacer layer 6 and a magnetic silicone resin (ϕ10×2 mm) serving as a polymer matrix layer 3 were bonded to an exterior body 21 of a unit cell (size: longitudinal 90×lateral 30×thickness 4 mm) of 1.44 Ah. These resin members and the battery were accommodated in a battery casing 11 (120×60×6 mm), and a magnetic sensor (EQ-431L manufactured by Asahi Kasei Microdevices Corporation) serving as a detection unit 4 was placed in the battery casing so as to be positioned above the center of the magnetic silicone resin. The arrangement was as shown in FIG. 2A, with an area ratio of (A+B)/C=0.9 and an elastic modulus ratio of Mb/Ma=1.

### EXAMPLE 2

The arrangement was as shown in FIG. 3A, with an area ratio of (A+B)/C=0.5. The other conditions were set to be the same as in the Example 1.

### EXAMPLE 3

The arrangement was as shown in FIG. 3B, with an area ratio of (A+B)/C=0.18. The other conditions were set to be the same as in the Example 1.

### COMPARATIVE EXAMPLE 1

As shown in FIG. 3C the spacer layer 6 was not provided. The area ratio was A/C=0.11.

### EXAMPLE 4

The construction of this Example was different from that of the Example 2 in the elasticity ratio of the spacer layer 6 in the area ratio construction of the Example 1. The spacer layer 6 was made of a material, such as a gel, having a comparatively lower elasticity than the polymer matrix layer 3, and the elastic modulus ratio was set to be Mb/Ma=0.02. The other conditions were the same as in the Example 2.

### EXAMPLE 5

The construction of this Example was different from that of the Example 2 in the elasticity ratio of the spacer layer 6 in the area ratio construction of the Example 2. The spacer layer 6 was made of a material, such as a rubber, having a comparatively higher elasticity than the polymer matrix layer 3, and the elastic modulus ratio was set to be Mb/Ma=90. The other conditions were the same as in the Example 2.

### EXAMPLE 6

The construction of this Example was different from that of the Example 2 in the elasticity ratio of the spacer layer 6 in the area ratio construction of the Example 2. The spacer layer 6 was made of a metal (brass), and the elastic modulus ratio was set to be Mb/Ma=10000. The other conditions were the same as in the Example 2.

TABLE 1

| | | | | Comparative |
|---|---|---|---|---|
| | Example 1 | Example 2 | Example 3 | Example 1 |
| Area ratio | 0.9 | 0.5 | 0.18 | 0.11 |
| (A + B)/C | | | | |
| Elastic modulus | 1 | 1 | 1 | — |
| ratio Mb/Ma | | | | |
| Arrangement | FIG. 2A | FIG. 3A | FIG. 3B | FIG. 3C |
| Stability [%] | 7.9% | 10.1% | 15.3% | 18.7% |
| Sensor sensitivity | 15 | 17 | 18 | 18 |
| [Gauss] | | | | |

The Comparative Example 1 had a construction in which only the polymer matrix layer 3 and the detection unit 4 were placed in the battery, and the spacer layer 6 was not provided. From Table 1, the stability was considerably aggravated to 18.7% by the vibration test. This seems to be because, by vibration, a positional shift was generated between the active area of the magnetic sensor serving as the detection unit 4 and the polymer matrix layer 3.

As shown in the Examples 1 to 3, the smaller the area ratio [(A+B)/C] was, that is, the larger the space between the battery and the casing was, the more conspicuous the lowering of this stability was.

Accordingly, as shown in the present Examples, the positional shift of the sensor brought about by the external turbulence such as vibration can be suppressed by covering most of the area of the placement surface F3 with the spacer layer 6, thereby providing a good sensor construction capable of stably detecting the battery swelling.

TABLE 2

| | Example 4 | Example 5 | Example 6 |
|---|---|---|---|
| Area ratio | 0.5 | 0.5 | 0.5 |
| (A + B)/C | | | |
| Elastic modulus | 0.02 | 90 | 10000 |
| ratio Mb/Ma | | | |
| Arrangement | FIG. 3A | FIG. 3A | FIG. 3A |
| Spacer layer | Low elasticity | High elasticity | Metal |
| | (gel) | (rubber) | (brass) |
| Stability [%] | 11.6% | 10.9% | 14.3% |
| Sensor sensitivity | 18 | 10 | 4 |
| [Gauss] | | | |

The constructions of the Examples 4 to 6 were such that the area ratio thereof was the same as that of the Example 2 except that the elastic modulus ratio of the spacer layer 6 was different. From Table 2, the stability was ensured in all of the Examples 4 to 6; however, the stability decreased a little as compared with the Example 2. This seems to be due to the adhesive force between the battery and the casing. In other words, this seems to be because, in the Examples a 5 and 6 having a comparatively high elasticity, the spacer layer 6 hardly followed the vibration and slid to generate a positional shift. Also, this seems to be because, in the Example 4 having a comparatively low elasticity, the spacer layer 6 followed the vibration to such a degree that the close adhesion could not be maintained, thereby generating a positional shift.

With respect to the sensor sensitivity the sensor sensitivity decreased according as the elasticity ratio of the spacer layer 6 was higher. This seems to be because the spacer layer 6 suppressed the battery swelling.

Accordingly, when the elastic modulus of the polymer matrix layer 3 and the elastic modulus of the spacer layer 6 are compared, it will be understood that it is preferable to avoid a construction in which the spacer layer has an extremely high elastic modulus, as in a metal, and it is preferable that the elastic moduli of the two members are of the same degree or in a neighborhood thereof.

As described above, a deformation detection sensor for a sealed secondary battery in accordance with the present embodiment, has a polymer matrix layer attached to a deformation detection object member among members constituting a battery; an opposite member sandwiching said polymer matrix layer together with said deformation detection object member; a spacer layer sandwiched, along with said polymer matrix layer, between said deformation detection object member and said opposite member; and a detection unit detecting a change in an external field arising in response to a deformation of said polymer matrix layer, wherein, in a planar view as viewed from said opposite member, when C is a surface area on a placement surface of said deformation detection object member for attaching said polymer matrix layer and said spacer layer. A is a contact surface area between said placement surface and said polymer matrix layer, and B is a contact surface area between said placement surface and said spacer layer, then a relationship of 0.15≤(A+B)/C≤1 is established.

According to this construction, a structure is provided in which the polymer matrix layer 3 and the spacer layer 6 are sandwiched between the deformation detection object member (exterior body 21) and the opposite member (casing 11), and the spacer layer 6 maintains the positional relationship between the deformation detection object member (exterior body 21) and the opposite member (casing 11), so that the detection stability against the positional shift caused by vibration can be improved.

In the present embodiment, the polymer matrix layer 3 and the spacer layer 6 are sandwiched between the casing 11 serving as the opposite member and the battery 2 serving as the deformation detection object member that is accommodated in the casing 11.

In accordance with the present embodiment, in a planar view, said spacer layer is arranged in an annular shape surrounding said polymer matrix layer.

In this manner, the spacer layer 6 in an annular shape surrounds the polymer matrix layer 3, so that the vibration in all directions can be supported, and the stability of detection can be improved.

In accordance with the present embodiment, when Ma is an elastic modulus of said polymer matrix layer, and Mb is an elastic modulus of said spacer layer, then a relationship of 0.02≤Mb/Ma≤500 is established.

According to this construction, a situation in which the deformation of the polymer matrix layer 3 is inhibited by the spacer layer 6 can be avoided, so that the aggravation of the sensor sensitivity can be suppressed.

In accordance with the present embodiment, satisfying Mb≤Ma.

This construction leads to a situation in which, when the polymer matrix layer 3 is about to be deformed in accordance with the deformation of the deformation detection object member (exterior body 21), the spacer layer 6 is deformed together without inhibiting the deformation, so that the sensor sensitivity can be readily ensured.

Structure employed at any of the foregoing embodiment(s) may be employed as desired at any other embodiments). The specific constitution of the various components is not limited only to the foregoing embodiment(s) but admits of any number of variations without departing from the gist of the present disclosure.

### Second Embodiment

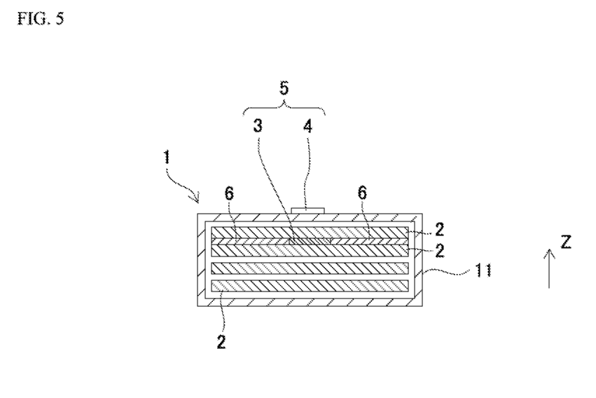

In the first embodiment, the polymer matrix layer 3 and the spacer layer 6 are sandwiched between the battery 2 serving as the deformation detection object member and the casing 11 serving as the opposite member; however, the present invention is not limited to this alone. For example, referring to FIG. 5, a battery module 1 has a casing 11 and a plurality of unit cells 2 that are accommodated in the inside of the casing 11. The polymer matrix layer 3 and the spacer layer 6 are sandwiched between the first cell 2 and the second cell 2. In this case, both of the first cell 2 and the second cell can be deformed, so that each of these is both the deformation detection object member and the opposite member. It goes without saying that the present invention is not limited to the first embodiment and the second embodiment, so that any member serving as the deformation detection object among the members constituting the battery module 1 can be used. The opposite member can be changed in various ways as long as the opposite member is a member that sandwiches the polymer matrix layer 3 and the spacer layer 6 together with the deformation detection object member.

### DESCRIPTION OF REFERENCE SIGNS

2 Sealed secondary battery
3 Polymer matrix layer
4 Detection unit
5 Deformation detection sensor
6 Spacer layer

1-8. (canceled)

9. A deformation detection sensor for a sealed secondary battery, the deformation detection sensor comprising:
a polymer matrix layer attached to a deformation detection object member among members constituting a battery;
an opposite member sandwiching said polymer matrix layer together with said deformation detection object member;
a spacer layer sandwiched, along with said polymer matrix layer, between said deformation detection object member and said opposite member; and
a detection unit detecting a change in an external field arising in response to a deformation of said polymer matrix layer, wherein,
in a planar view as viewed from said opposite member, when C is a surface area on a placement surface of said deformation detection object member for attaching said polymer matrix layer and said spacer layer. A is a contact surface area between said placement surface and said polymer matrix layer, and B is a contact surface area between said placement surface and said spacer layer, then a relationship of 0.15≤(A+B)/C≤1 is established.

10. The deformation detection sensor according to claim 9, wherein said polymer matrix layer and said spacer layer are sandwiched between a casing and a battery accommodated in said casing.

11. The deformation detection sensor according to claim 9, wherein said polymer matrix layer and said spacer layer are sandwiched between a first cell and a second cell.

12. The deformation detection sensor according to claim 9, wherein, in a planar view, said spacer layer is arranged in an annular shape surrounding said polymer matrix layer.

13. The deformation detection sensor according to claim 9, wherein, when Ma is an elastic modulus of said polymer matrix layer, and Mb is an elastic modulus of said spacer layer, then a relationship of 0.02≤Mb/Ma≤500 is established.

14. The deformation detection sensor according to claim 10, wherein, when Ma is an elastic modulus of said polymer matrix layer, and Mb is an elastic modulus of said spacer layer, then a relationship of 0.02≤Mb/Ma≤500 is established.

15. The deformation detection sensor according to claim 11, wherein, when Ma is an elastic modulus of said polymer matrix layer, and Mb is an elastic modulus of said spacer layer, then a relationship of 0.02≤Mb/Ma≤500 is established.

16. The deformation detection sensor according to claim 12, wherein, when Ma is an elastic modulus of said polymer matrix layer, and Mb is an elastic modulus of said spacer layer, then a relationship of 0.02≤Mb/Ma≤500 is established.

17. The deformation detection sensor according to claim 13, satisfying Mb≤Ma.

18. The deformation detection sensor according to claim 14, satisfying Mb≤Ma.

19. The deformation detection sensor according to claim 15, satisfying Mb≤Ma.

20. The deformation detection sensor according to claim 16, satisfying Mb≤Ma.

21. The deformation detection sensor according to claim 9, wherein said polymer matrix layer contains a magnetic filler, and said detection unit detects a change in a magnetic field.

22. The deformation detection sensor according to claim 10, wherein said polymer matrix layer contains a magnetic filler, and said detection unit detects a change in a magnetic field.

23. The deformation detection sensor according to claim 11, wherein said polymer matrix layer contains a magnetic filler, and said detection unit detects a change in a magnetic field.

24. The deformation detection sensor according to claim 12, wherein said polymer matrix layer contains a magnetic filler, and said detection unit detects a change in a magnetic field.

25. A sealed secondary battery to which a deformation detection sensor according to claim 9 is attached.
